(19) United States
(12) Patent Application Publication
(10) Pub. No.: US 2014/0064620 A1
(43) Pub. Date: Mar. 6, 2014

(54) INFORMATION PROCESSING SYSTEM, STORAGE MEDIUM AND INFORMATION PROCESSING METHOD IN AN INFOMRATION PROCESSING SYSTEM

(71) Applicant: KABUSHIKI KAISHA TOSHIBA, Tokyo (JP)

(72) Inventor: Qi Zhang, Nishitama-gun (JP)

(73) Assignee: KABUSHIKI KAISHA TOSHIBA, Tokyo (JP)

(21) Appl. No.: 13/680,374

(22) Filed: Nov. 19, 2012

(30) Foreign Application Priority Data
Sep. 5, 2012 (JP) 2012-195260

(51) Int. Cl. G06K 9/18

(52) U.S. Cl. CPC G06K 9/18
USPC 382/187

(57) ABSTRACT

According to one embodiment, an information processing system includes a recorder and a first detector. The recorder is configured to record stroke data representing strokes written by hand. An order relationship between the stroke data items is recognizable in the stroke data. The first detector is configured to detect an orientation of a character corresponding to the strokes represented by the stroke data, based on a positional relationship and an order relationship between at least two strokes.

### CROSS-REFERENCE TO RELATED APPLICATIONS

This application is based upon and claims the benefit of priority from Japanese Patent Application No. 2012-195260, filed Sep. 5, 2012, the entire contents of which are incorporated herein by reference.

### FIELD

Embodiments described herein relate generally to a technique of processing documents input in writing by hand.

### BACKGROUND

In recent years, various types of information processing apparatuses, such as tablet computers, personal digital assistants (PDAs) and smartphones, have been developed, which are portable and battery-driven. Most of these apparatuses include a touchscreen display, enabling the user to input data with ease.

The user may touch the menu or objects displayed on the touchscreen display, to instruct the information processing apparatus to perform the function associated with the menu or the objects.

The touchscreen display is used, not only to instruct the information processing apparatus to perform functions, but also to input documents written by hand. Recently, the user may participate in a conference, taking the information processing apparatus with him or her. At the conference, the user touches the touchscreen display, taking memos in by hand. Any information processing apparatus with a character recognizing function can generate text data representing a document written by hand on the touchscreen display. Various technique of processing handwritten data has hitherto been proposed.

Assume that the user writes “ABC” by hand on the touchscreen display. Then, the information processing apparatus including the character recognizing function first extracts the region in which “ABC” has been written by hand, as one character block, and then recognizes each character. The three characters, “A”, “B” and “C”, which exist in one character block, are processed as one character string (object) “ABC”.

The screen (i.e., input face) of the touchscreen display is rectangular in most cases, and any information processing apparatus including a touchscreen display can be used while directed either vertically or horizontally. Japanese characters can be written, either in vertical lines or in horizontal lines. Therefore, three letters “A”, “B” and “C” written in a vertical line, they may be processed not as a character string as the user desires. Consequently, they are processed, in many cases, as three characters (i.e., objects) independent of one another.

### BRIEF DESCRIPTION OF THE DRAWINGS

A general architecture that implements the various features of the embodiments will now be described with reference to the drawings. The drawings and the associated descriptions are provided to illustrate the embodiments and not to limit the scope of the invention.

FIG. 1 is an exemplary perspective view showing the outer appearance of an information processing system (information processing apparatus) according to an embodiment.

FIG. 2 is an exemplary diagram showing how the information processing apparatus according to the embodiment operates in association with external apparatuses (a personal computer and a server).

FIG. 3 is an exemplary diagram showing an example of data handwritten on the touchscreen display of the information processing apparatus according to the embodiment.

FIG. 4 is an exemplary diagram explaining how the information processing apparatus according to the embodiment stores handwritten data in a storage medium.

FIG. 5 is an exemplary diagram showing the system configuration of the information processing apparatus according to the embodiment.

FIG. 6 is an exemplary block diagram showing the functions of the digital notebook application program running on the information processing apparatus according to the embodiment.

FIG. 7 is an exemplary diagram explaining the principal of detecting the orientation of a character by a digital notebook application program running on the information processing apparatus according to the embodiment.

FIG. 8 is an exemplary first diagram showing an exemplary method of detecting the orientation of a character by the digital notebook application program running on the information processing apparatus according to the embodiment.

FIG. 9 is an exemplary second diagram showing an exemplary method of detecting the orientation of a character by the digital notebook application program running on the information processing apparatus according to the embodiment.

FIG. 10 is an exemplary third diagram showing an exemplary method of detecting the orientation of a character by the digital notebook application program running on the information processing apparatus according to the embodiment.

FIG. 11 is an exemplary diagram showing how a document is adjusted by the digital notebook application program running on the information processing apparatus according to the embodiment.

FIG. 12 is an exemplary flowchart showing the sequence of processes to the digital notebook application program running on the information processing apparatus according to the embodiment.

### DETAILED DESCRIPTION

Various embodiments will be described hereinafter with reference to the accompanying drawings.

In general, according to one embodiment, an information processing system includes a recorder and a first detector. The recorder is configured to record stroke data representing strokes written by hand. An order relationship between the stroke data is recognizable in the stroke data. The first detector is configured to detect an orientation of a character corresponding to the strokes represented by the stroke data, based on a positional relationship and an order relationship between at least two strokes.

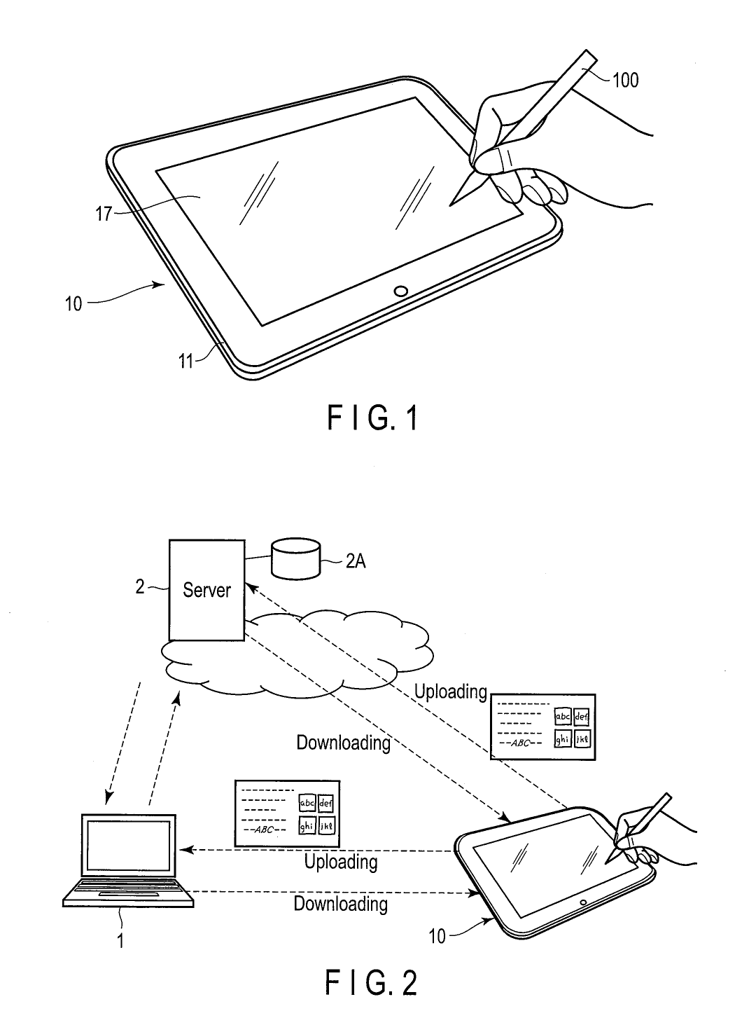

An information processing apparatus according to the embodiment can be implemented in the form of, for example, a tablet computer, a notebook computer, a smartphone or a PDA, with which a user can input data written by hand with either a pen or a finger. FIG. 1 is an exemplary perspective view showing the outer appearance of an information processing system (information processing apparatus) according to the embodiment. As shown in FIG. 1, the information processing apparatus is a tablet computer 10. The tablet computer 10 includes a main unit 11 and a touchscreen display 17. The touchscreen display 17 is laid on, and secured to, the upper surface of the main unit 11.

The main unit 11 has a housing shaped like a thin box. The touchscreen display 17 includes a flat panel display and a sensor. The sensor is configured to detect any position at which the flat panel display is touched with the pen or the finger. The flat panel display may be, for example, a liquid crystal display (LCD). The sensor can be, for example, a touchpanel of electrostatic capacitance type or a digitizer of electromagnetic type. Hereinafter, the embodiment shall be described on the assumption that the touchscreen display 17 incorporates a digitizer and a touchpanel, i.e., two types of sensors.

The digitizer and the touchpanel are provided, covering the screen of the flat panel display. The touchscreen display 17 can detect whether the screen has been touched not only with a finger, but also with a pen 100. The pen 100 is, for example, an electromagnetic induction pen. The user can use an external object (pen 100 or finger) to write characters by hand on the screen of the touchscreen display 17. Any strokes made on the screen with the external object (pen 100 or finger) are displayed on the screen. Each stroke is the locus of the external object being moved on the screen, in contact with the screen. A set of strokes defines a character or a figure. Many sets of strokes therefore constitute a handwritten document.

In the embodiment, the handwritten document is stored in a storage medium, not as image data, but as time-series data representing both the coordinate locus of each stroke and the order in which the strokes have been made. As will be described later in detail, the time-series data is generally a set of stroke data items corresponding to strokes, respectively. Each stroke data item represents a stroke, or the time-series ordinates of the stroke. The order in which the stroke data items are arranged is equivalent to the order in which the strokes have been made, forming a handwritten character or a handwritten figure.

The tablet computer 10 can read time-series data from the storage medium and can display, on the screen of the touchscreen display 17, the handwritten document corresponding to the time-series data representing the loci of the finger or pen that have moved on the screen. The tablet computer 10 includes an editing function, which enables the user to use an “eraser” tool, a range-selecting tool, and some other editing tools. The user may use these editing tools to erase or move any stroke in the handwritten document displayed. The editing function further enables the user to erase the history of some hand-writing procedure.

In the embodiment, any time-series data (handwritten document) may be managed as one page or pages. In this case, the time-series data (handwritten document) is divided into data units, each of which can be displayed in one screen and can be stored as one page. Further, the page may be changed in size. In this case, the page can be expanded to a size larger than one screen, and a handwritten document larger than the screen can be handled as one page larger than the screen. If one page is too large to display on the display at a time, it may be reduced in size or may be moved, or scrolled vertically or horizontally.

FIG. 2 is an exemplary diagram showing how the tablet computer 10 according to the embodiment operates in association with external apparatuses (i.e., a personal computer 1 and a server 2). The tablet computer 10 can operate in association with the personal computer 1 or in a cloud computing system. That is, the tablet computer 10 includes a wireless communication device such as wireless LAN, and can perform wireless communication with the personal computer 1. The tablet computer 10 can further achieve communication with the server 2 existing on the Internet. The server 2 may be of the type that performs on-line storage service and any other various cloud computing services.

The personal computer 1 incorporates a storage device such as a hard disk drive (HDD). The tablet computer 10 transmits time-series data (written document) via the network to the personal computer 1. In the personal computer 1, the time-series data can be recorded (or uploaded) in the HDD. To accomplish secure communication between the personal computer 1 and the tablet computer 10, the personal computer 1 may authenticate the tablet computer 10. In this case, a dialog box may be displayed on the screen of the tablet computer 10, prompting the user to input his or her ID or password, or the ID of the tablet computer 10 may be automatically transmitted from the tablet computer 10 to the personal computer 1.

Therefore, the tablet computer 10 can process many time-series data items, i.e., a great amount of time-series data (handwritten documents) even if its data storage capacity is small.

Moreover, the tablet computer 10 can read (download) one or more time-series data items recorded on the HDD of the personal computer 1 and can display the strokes (i.e., loci of the external object) represented by the time-series data read, on the screen of its touchscreen display 17. In this case, the touchscreen display 17 may display a table of thumbnails generated by reducing the pages of the time-series data items (handwritten documents). Further, one of the thumbnails may be selected and the page identified with the thumbnail selected may then be displayed in the ordinary size on the touchscreen display 17.

Still further, the tablet computer 10 may communicate not with the personal computer 1, but with the server 2 available in the cloud computing system, which provides a storage service. The tablet computer 10 can transmit the time-series data items (handwritten documents) to the server 2 through the network. The time-series data items can be recorded (uploaded) in the storage device 2A incorporated in the server 2. The tablet computer 10 can further read (download) any time-series data recorded in the storage device 2A of the server 2, and can display the strokes (i.e., loci of the external object) represented by the time-series data read, on the screen of its touchscreen display 17.

Thus, in the embodiment, the storage medium storing the time-series data may be the storage device incorporated in the tablet computer 10, the storage device provided in the personal computer 1 or the storage device provided in the server 2.

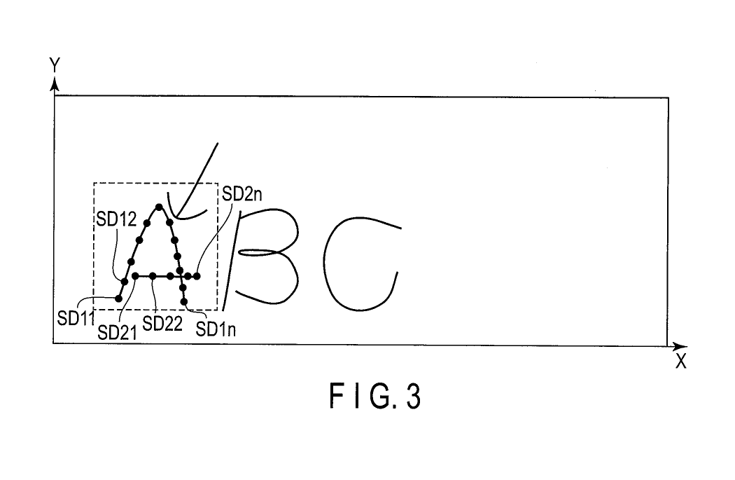

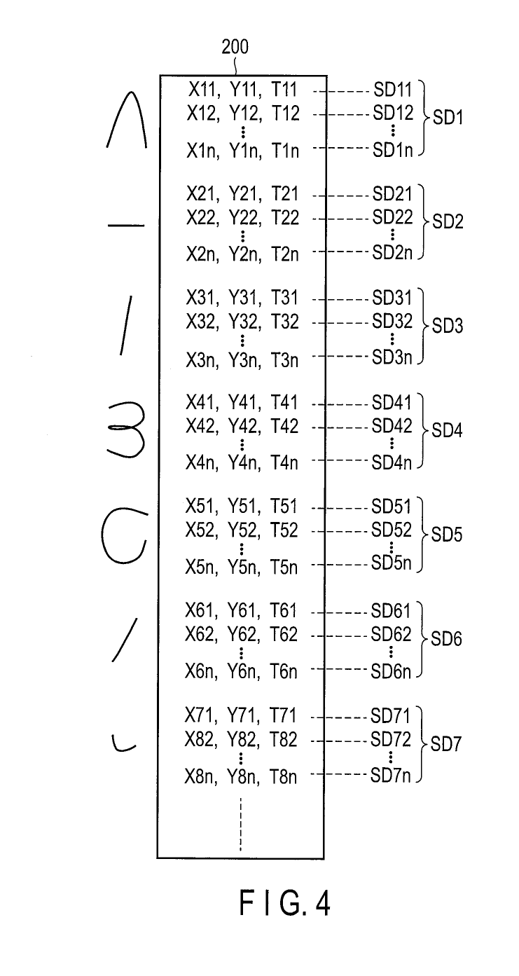

How the strokes the user has written by hand (i.e., characters, marks, a figure or a table) are related with the time-series data will be explained with reference to FIG. 3 and FIG. 4. FIG. 3 is an exemplary diagram showing an example of a document (i.e., handwritten character string) written by hand with a pen 100 on the touchscreen display 17.

In handwritten documents, characters or a figure is written by hand over the characters or figure already written by hand in many cases. As shown in FIG. 3, a character string “ABC” may be written by hand, first “A”, then “B” and finally “C”, and an arrow may then be written by hand near the handwritten letter “A”.

The handwritten character “A” is composed of two strokes (“̂” and “-”), or two loci of the pen 100 moved on the screen of the touchscreen display 17. The first locus “̂” of the pen 100 is sampled in real time at regular time intervals, generating time-series coordinates SD11, SD12, . . . , SD1n. Then, the second locus “-” of the pen 100 is similarly sampled, generating time-series coordinates SD21, SD22, . . . , SD2n.

The handwritten character “B” is composed of two strokes, too, or two loci of the pen 100. The handwritten character “C” is composed of one stroke, or one locus of the pen 100. The handwritten arrow is composed of two strokes, or two loci of the pen 100.

FIG. 4 shows the time-series data 200 representing the handwritten document shown in FIG. 3. The time-series data 200 contains stroke data items SD1, SD2, . . . , SD7. In the time-series data 200, stroke data items SD1, SD2, . . . , SD7 are arranged in the order the strokes they represent, respectively, have been made in writing by hand.

In the time-series data 200, the first two stoke data items SD1 and SD2 represent the two strokes forming the handwritten letter “A”. The third and fourth stroke data items SD3 and SD4 represent the two strokes forming the handwritten letter “B”. The fifth stroke data item SD5 represents the stroke forming the handwritten letter “C”. The sixth and seventh stroke data items SD6 and SD7 represents the two stokes forming the handwritten arrow.

Each stroke data item represents time-series coordinates corresponding to one stroke, or a plurality of time-series coordinates that define a stroke. In each stroke data item, the coordinates are arranged in time series, representing how the stroke has been made. As to the handwritten letter “A”, for example, stroke data item SD1 contains n time-series coordinate data items defining the stroke “̂”, i.e., coordinate SD11, SD12, . . . , SD1n, and stroke data item SD2 contains n time-series coordinate data items defining the stroke “-”, i.e., coordinates SD21, SD33, . . . , SD2n. Note that the number of coordinate data items may differ, from stroke data item to stroke data item.

Each coordinate data item represents the X ordinate and Y ordinate of one point on one stroke, or on one locus. The coordinate data item representing the coordinate SD11, for example, represents X ordinate (X11) and Y ordinate (Y11) defining the start point of the stroke “̂”. The coordinate data item representing the coordinate SD1n represents X ordinate (X1n) and Y ordinate (Y1n) defining the end point of the stroke “̂”.

Each coordinate data item contains time stamp data T. The time stamp data T represents the time the point corresponding to the coordinate was written by hand. The handwriting time is either an absolute time (for example, year, month, day, hour and second) or a relative time with respect to a reference time. The absolute time (year, month, day, hour and second) the user started making a stroke may be added to the stroke data item, and the relative time (with respect to the absolute time) may be added, as time stamp data, to each coordinate data item contained in the stroke data item.

Further, data (Z) representing the tool force may be added to each coordinate data item.

The time-series data 200 of such a structure as shown in FIG. 4 may represent not only the stokes, i.e., loci of the pen 100 moved on the touchscreen display 17, but also the order in which the strokes have been made in writing a character or a figure by hand. Therefore, if the time-series data 200 is used, the head of the handwritten arrow can be recognized as a character or a figure different from the handwritten letter “A” even if the head of the handwritten arrow overlaps the letter “A” or is located near the letter “A”.

Assume that the user has designated such a region in the screen, as indicated by a broken-line square shown in FIG. 3. The two stokes forming the letter “A” and one stroke representing the distal end part of the handwritten arrow exist in the broken-line square. Not only the two stokes forming the letter “A”, but also the stroke representing the distal end part of the handwritten arrow may be usually selected as those parts of the time-series data, which should be processed.

In the embodiment, however, the use of the time-series data 200 can exclude the stroke representing the distal end part of the handwritten arrow from the time-series data, and is never processed. More precisely, the time-series data 200 is analyzed, whereby the two strokes (represented by stoke data items SD1 and SD2) forming the handwritten letter “A” are determined to have been written cursively. Further, the timing of handwriting the distal end part of the handwritten arrow (represented by stroke data item SD7) is determined to differ from the timing of writing by hand the two strokes forming the letter “A”. Thus, the stroke representing the distal end part of the handwritten arrow can be excluded from the time-series data.

Further, the sequence of stroke data items SD1, SD2, . . . , SD7 indicates the order in which the strokes of a character have been made, as described above. The sequence of, for example, stroke data items SD1 and SD2 shows that the stroke “̂” and the stroke “-” have been written by hand in the order they are mentioned. Hence, two handwritten characters similar in shape can be recognized as different from each other even if they differ in the order in which the strokes have been written by hand.

Still further, any handwritten document is stored as time-series data 200 that is a set of time-series stroke data items, not data acquired by recognizing images or characters. Handwritten characters can be handled in the same way, irrespective of the language in which they are used. So structured, the time-series data 200 can be commonly used in the various languages all over the world.

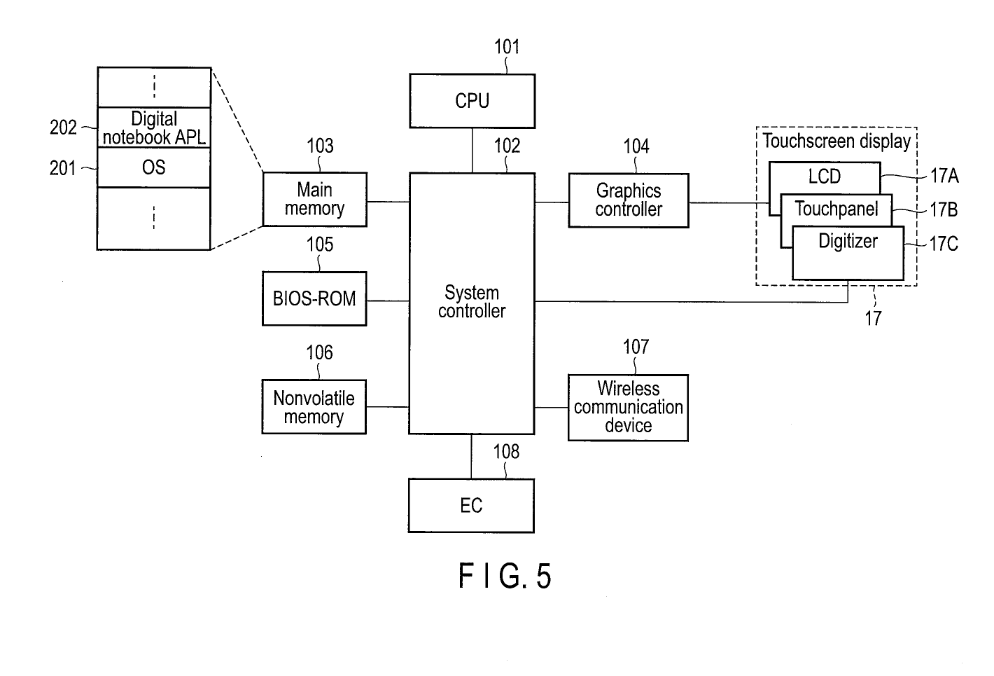

FIG. 5 is an exemplary diagram showing the system configuration of the tablet computer 10.

As shown in FIG. 5, the tablet computer 10 includes a CPU 101, a system controller 102, a main memory 103, a graphics controller 104, a BIOS-ROM 105, a nonvolatile memory 106, a wireless communication device 107, and an embedded controller (EC) 108.

The CPU 101 is a processor used to control the various modules incorporated the tablet computer 10. The CPU 101 executes the various software items loaded into the main memory 103 from the nonvolatile memory 106, which is a storage device. The software items include an operating system (OS) 201 and various application programs. Among the application programs are a digital notebook application program 202. The digital notebook application program 202 includes the function of generating handwritten documents, the function of editing any handwritten document generated, the function of retrieving handwriting patterns, and the function of recognizing characters and figures.

The CPU 101 executes also a basic input/output system (BIOS) stored in the BIOS-ROM 105. The BIOS is a program to control hardware.

The system controller 102 is a device configured to connect the other components of the tablet computer 10 to the local bus for the CPU 101. The system controller 102 incorporates a memory controller that controls the access to the main memory 103. The system controller 102 includes the function of communicating with the graphics controller 104 through a serial bus of the PCI EXPRESS standard.

The graphics controller 104 is the display controller that controls an LCD 17A used as the display monitor of the tablet computer 10. The graphics controller 104 generates a display signal, which is supplied to the LCD 17A. The LCD 17A displays the screen image represented by the display signal. The LCD 17A includes a touchpanel 17B and a digitizer 17C. The touchpanel 17B is a pointing device of the electrostatic capacitance type, which enables the user to input data at the screen of the LCD 17A. The touchpanel 17B detects the position at which the user's finger touches the screen and also the motion the user's finger undergoes on the screen. The digitizer 17C is a pointing device of the electromagnetic induction type, which enables the user to input data at the screen of the LCD 17A. The digitizer 17C detects the position at which the pen 100 touches the screen and also the motion the pen 100 undergoes on the screen.

The wireless communication device 107 is a device configured to achieve wireless communication such as the wireless LAN communication or the 3G mobile communication. EC 108 is a single-chip microcomputer that incorporates an embedded controller configured to control power consumption. EC 108 includes the function of turning on or off the tablet computer 10 as the user pushes the power button of the tablet computer 10.

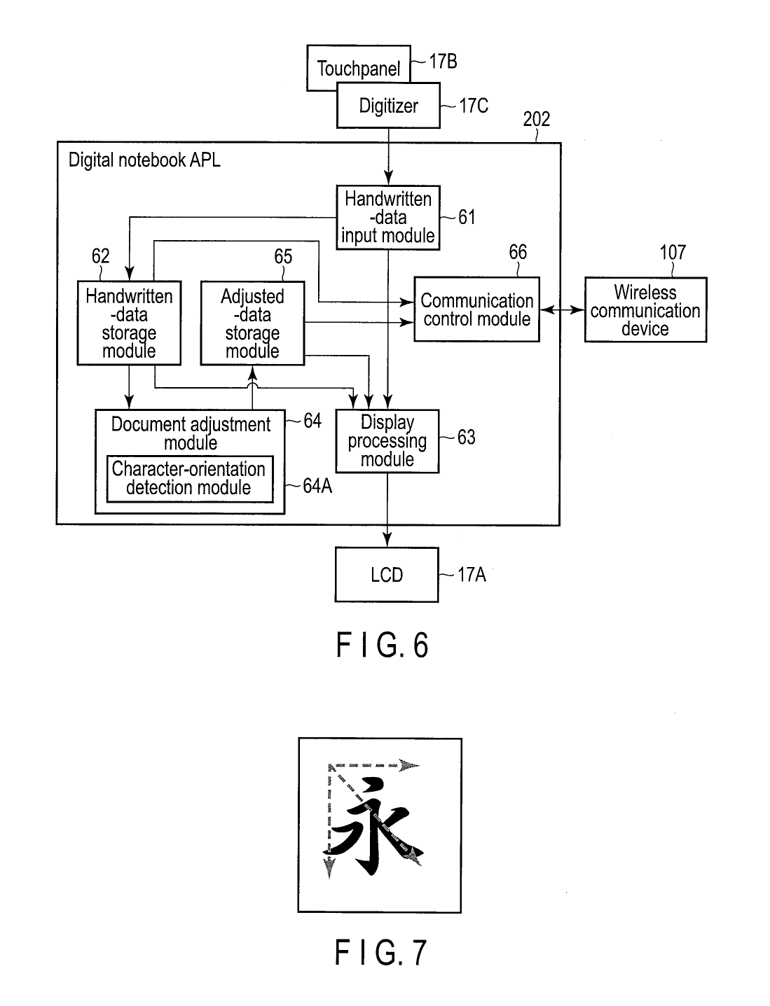

FIG. 6 is an exemplary block diagram showing the functions of the digital notebook application program 202 that the tablet compute 10 executes.

As shown in FIG. 6, the digital notebook application program 202 includes a handwritten-data input module 61, a handwritten-data storage module 62, a display processing module 63, a document adjustment module 64, an adjusted-data storage module 65, and a communication control module 66.

As described above, the touchscreen display 17 detects any touch on the screen, at either the touchpanel 17B or the digitizer 17C. The handwritten-data input module 61 is a module that receives the detection signal output from the touchpanel 17B or the digitizer 17C. The detection signal input by the handwritten-data input module 61 is supplied to the handwritten-data storage module 62. The handwritten-data storage module 62 is a module that stores the detection signal, as time-series data 200 described above, in the storage medium (i.e., nonvolatile memory 106) provided in the tablet computer 10.

The detection signal input by the handwritten-data input module 61 is supplied also to the display processing module 63. The display processing module 63 is a module that displays handwritten strokes (i.e., handwritten character) on the LCD 17A of the touchscreen display 17, upon receipt of the detection signal. The display processing module 63 can display any stoke written by hand in the past on the LCD 17A of the touchscreen display 17, on the basis of the time-series data 200 stored in the handwritten-data storage module 62.

The document adjustment module 64 is a module that includes a function of automatically adjusting any handwritten document to a typed document. The document adjustment module 64 analyzes the time-series data 200 stored in the handwritten-data storage module 62, extracts the characters and figures from the data 200, and changes the data to an electronic document, while maintaining the layout of the handwritten document. In order to maintain the layout of the handwritten document while changing the data to an electronic document, the document adjustment module 64 includes a character-orientation detection module 64A. The character-orientation detection module 64A shall be described later.

The adjusted-data storage module 65 is a module that stores the electronic document generated by the document adjustment module 64, in the storage medium (i.e., nonvolatile memory 106) provided in the tablet computer 10. The display processing module 63 can display the electronic document stored in the adjusted-data storage module 65, on the LCD 17A of the touchscreen display 17.

The communication control module 66 is a module that receives the time-series data 200 stored in the handwritten-data storage module 62 or the electronic document stored in the adjusted-data storage module 65 and transmits the data 200 or the electronic document to the personal computer 1 or server 2 through the wireless communication device 107. The communication control module 66 can receive the time-series data 200 or the electronic document from the personal computer 1 or server 2 through the wireless communication device 107.

The operating principle of the character-orientation detection module 64A provided in the document adjustment module 64 that includes a function of automatically adjusting any handwritten document to a typed document will be explained below.

The character-orientation detection module 64A is a module that detects the orientation of any character from the order in which strokes have been made to form the character. Characters (particularly those used in Japanese) are written by hand, with each stroke extending rightwards, downwards, or obliquely from the upper left to the lower right, as is shown in FIG. 7. The character-orientation detection module 64A utilizes this handwriting manner to detect the orientation of each handwritten character.

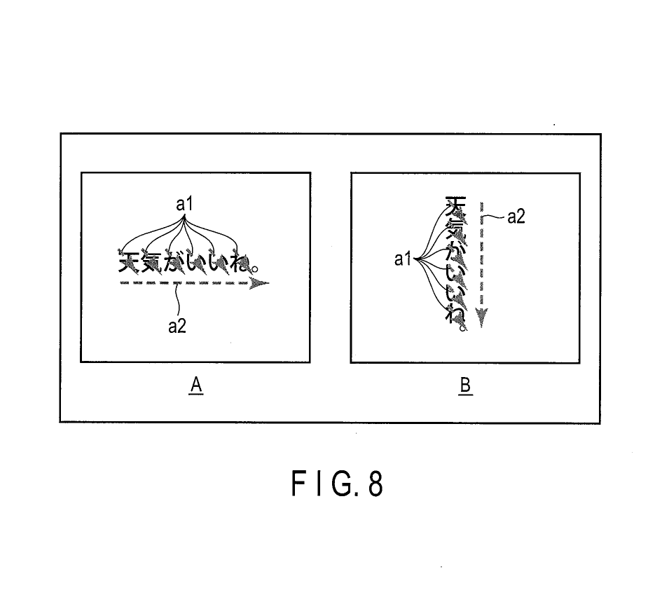

Assume that the user inputs a Japanese sentence meaning “It is fine, isn't it?” as shown in FIG. 8. Shown at A in FIG. 8 is a horizontal character string representing the Japanese sentence. Shown at B in FIG. 8 is a vertical character string representing the Japanese sentence.

In the document adjustment module 64, the character-orientation detection module 64A detects the orientation (a1) of each character of the character string, either horizontal (A) or vertical (B). After the character-orientation detection module 64A has detected the orientation of each character, the document adjustment module 64 detects the direction (a2) in which the characters of the string are arranged. A character block region can thereby set appropriately so that the Japanese sentence meaning “It is fine, isn't it?” may be processed as one character string.

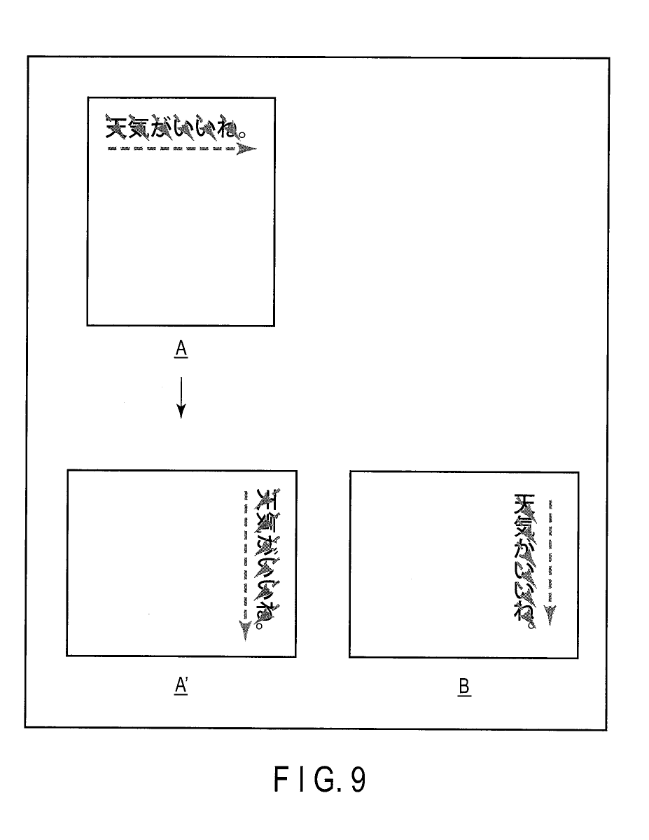

In the case of FIG. 8, the sentence is written by hand on the screen of the touchscreen display 17 set in the landscape orientation (longer in horizontal direction than in vertical direction). Instead, the sentence may be written by hand on the screen of the touchscreen display 17 set in the portrait orientation (longer in vertical direction than in horizontal direction), as is shown in FIG. 9.

In FIG. 9, A represents a horizontal character string, or Japanese sentence meaning “It is fine, isn't it?” which is written by hand on the screen of the touchscreen display 17. A′ represents a character string, or the same handwritten Japanese sentence, moved from position A on the screen of the touchscreen display 17 and rotated by 90 degrees. As seen from the horizontal character string A and the vertical character string A′, whether the screen of the touchscreen display 17 is set in the landscape position or the portrait position cannot be determined from only the direction the characters of the string are arranged. Nor can it be determined whether the character string is vertical or horizontal.

The document adjustment module 64 can determine can determine whether the screen of the touchscreen display 17 is set in the landscape position or the portrait position. This is because the output of the character-orientation detection module 64A represents the orientation of each character of the string. The document adjustment module 64 can determine (from the time-series data 200) not only in which direction each character of any string is oriented vertical or horizontal, but also whether the character string is vertical or horizontal. Note that this instance is concerned with only one Japanese line meaning “It is fine, isn't it?”. Nonetheless, the character-orientation detection module 64A can correctly detect the orientation of any handwritten character and the direction in which handwritten characters are arranged, even if many handwritten characters are displayed in many rows and columns, all over the screen of the touchscreen display 17.

The character-orientation detection module 64A can thus detect the orientation of the touchscreen display 17, too. For example, when the tablet computer 10 is turned on, the document adjustment module 64 causes the user to write any character or any character string by hand on the screen of the touchscreen display 17, the document adjustment module 64 can determine in which position the user has set the touchscreen display 17, the landscape position or the portrait position.

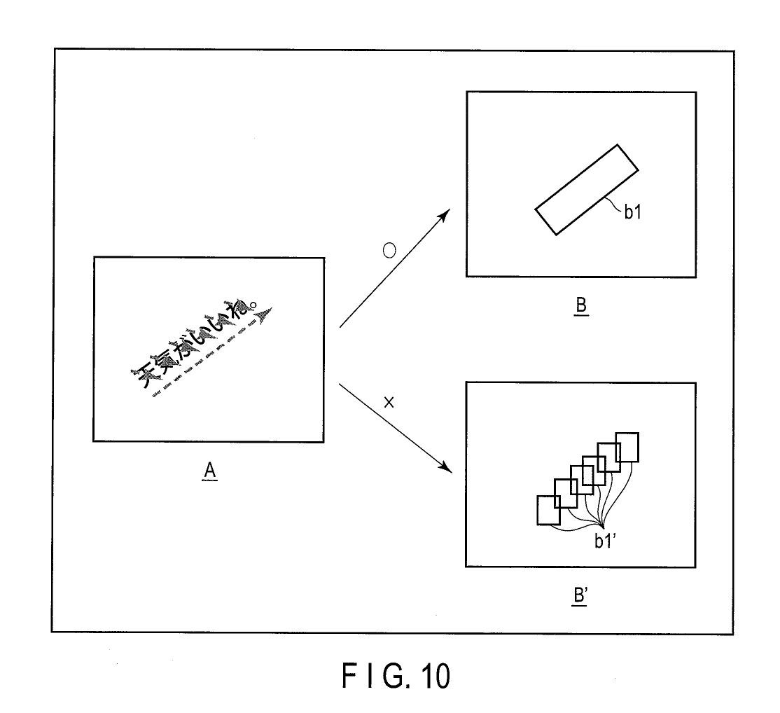

Assume that the Japanese sentence meaning “It is fine, isn't it?” has been written by hand obliquely as shown at A in FIG. 10 on the screen of the touchscreen display 17. Then, character block regions (b1′) will probably be set as shown at B′ in FIG. 10, in most cases, for the respective characters constituting the Japanese sentence. That is, the characters constituting the sentence may be processed one by one in all probability, not as a Japanese character string meaning “It is fine, isn't it?”

In order to process, as one character string, the Japanese characters forming a slanting line meaning “It is fine, isn't it?”, the document adjustment module 64 adjusts the orientation of the character block (b1) as shown at B in FIG. 10 in accordance with the orientations of the respective Japanese characters detected by the character-orientation detection module 64A, and with the direction the characters are arranged (determined from the time-series data 200).

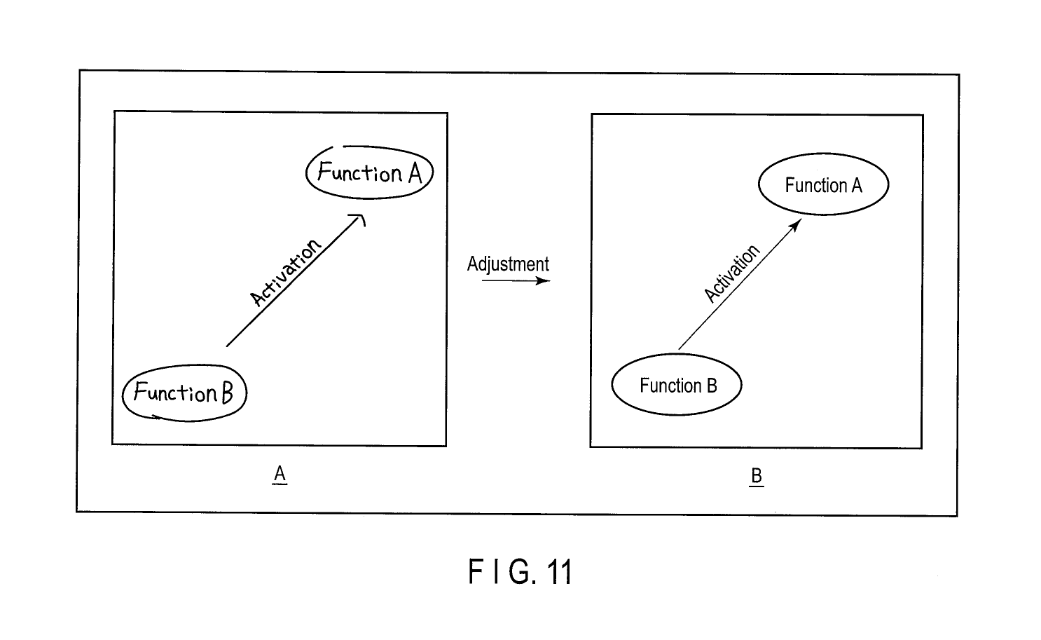

Since characters sequentially written by hand can be processed as one character string, the document adjustment module 64 can change the handwritten data to an electronic document, while maintaining the layout of the handwritten document. How the module 64 can maintain the layout of the handwritten document will be explained with reference to FIG. 11. Assume that a character string, or “activation” is written by hand obliquely along an arrow as shown at A in FIG. 11. Then, the character block region is adjusted in orientation, whereby the handwritten word is changed to a typewritten word that extends along the arrow as shown at B in FIG. 11. Thus, the document adjustment module 64 can adjust a handwritten document to a typed document in accordance with the data representing the arrangement of character blocks.

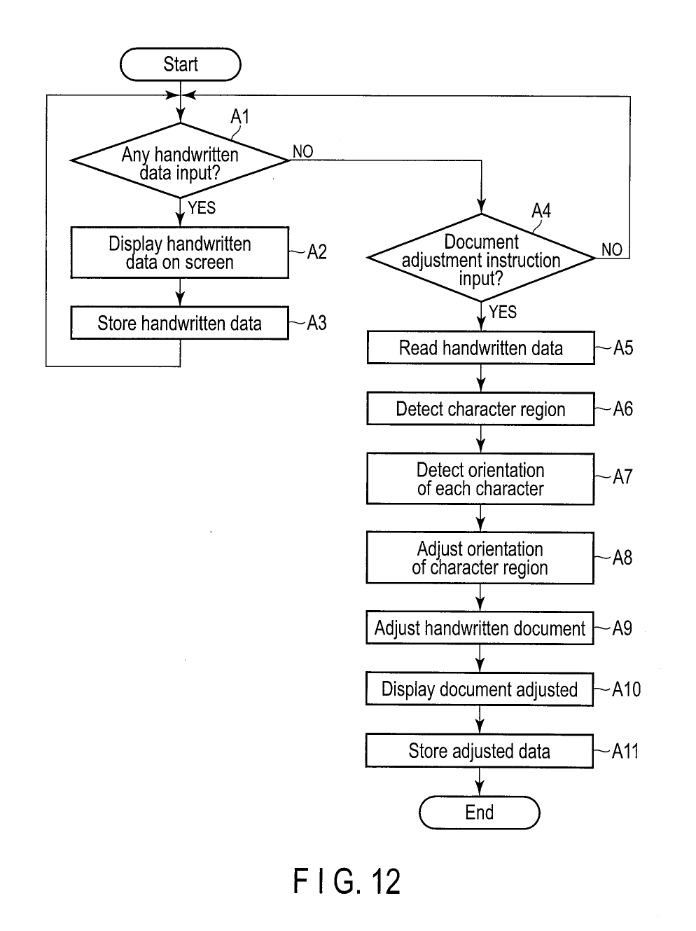

FIG. 12 is an exemplary flowchart showing the sequence of processes to the digital notebook application program 202 running on the tablet computer 10.

If data is written by hand on the touchscreen display 17 (YES in Block A1), the digital notebook application program 202 causes the touchscreen display 17 to display the handwritten data on the screen (Block A2). The data (time-series data 200) that corresponds to the handwritten data is stored (Block A3).

If no data is written by hand on the touchscreen display 17 (NO in Block A1), it is determined whether a document adjustment instruction has been input (Block A4). If a document adjustment instruction has been input (YES in Block A4), the digital notebook application program 202 reads the handwritten data (Block A5). Then, a character region is detected (Block A6). The digital notebook application program 202 detects the orientation of each character existing in the character region detected (Block A7), and then adjust the orientation of the character region (Block A8).

Next, the digital notebook application program 202 adjusts the handwritten document, or changes the document to an electronic document (Block A9), and displays the electronic document at the touchscreen display 17 (Block A10). The digital notebook application program 202 finally stores adjusted data corresponding to the document so adjusted (Block A11).

As has been described, the information processing system according to the embodiment can determine the orientation of each of handwritten characters, and can utilize the orientation to adjust a document constituted by the handwritten characters.

In the embodiment, the orientation of any character is detected in accordance with software (i.e., program). If the software is installed on a general-purpose computer via a computer-readable storage medium storing the software, the same advantage as achieved in the embodiment will be easily attained.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing system comprising:
a recorder configured to record stroke data representing strokes written by hand, an order relationship between the stroke data being recognizable in the stroke data; and
a first detector configured to detect an orientation of a character corresponding to the strokes represented by the stroke data, based on a positional relationship and an order relationship between at least two strokes.

2. The system of claim 1, further comprising a recognition module configured to recognize the character corresponding to the strokes represented by the stroke data,
wherein the recognition module is configured to adjust an orientation of a character block region including at least two characters as one character string, based on the orientation of the character detected by the first detector.

3. The system of claim 2, further comprising an adjusted document display module configured to display characters corresponding to character codes acquired by the recognition module, based on position data of a character block region extracted by the recognition module.

4. The system of claim 1, wherein the first detector is configured to detect the orientation of the character corresponding to the strokes represented by the stroke data, by comparing the direction of motion from first stroke data to second stroke data following the first stroke data with two directions prescribed as horizontal and vertical direction for moving a writing instrument, respectively.

5. The system of claim 1, further comprising a second detector configured to detect an orientation of a touchscreen display based on the orientation of the character detected by the first detector.

6. The system of claim 1, further comprising a handwritten-document display module configured to display loci represented by the stroke data to a touchscreen display.

7. A computer-readable, non-transitory storage medium having stored thereon a computer program which is executable by a computer, the computer program controlling the computer to function as:
a recording module configured to record stroke data representing strokes written by hand, an order relationship between the stroke data being recognizable in the stroke data; and
a first detector configured to detect an orientation of a character corresponding to the strokes represented by the stroke data, based on a positional relationship and an order relationship between at least two strokes.

8. An information processing method in an information processing system, the method comprising:
recording stroke data representing strokes written by hand, an order relationship between the stroke data being recognizable in the stroke data; and
detecting an orientation of a character corresponding to the strokes represented by the stroke data, based on a positional relationship and an order relationship between at least two strokes.
